(19) United States
(12) Patent Application Publication
(10) Pub. No.: US 2023/0084973 A1
(43) Pub. Date: Mar. 16, 2023

(54) METHOD OF MANUFACTURING LIQUID CRYSTAL PANEL WITH SPECIAL DIMENSION AND LIQUID CRYSTAL PANEL WITH SPECIAL DIMENSION

(71) Applicant: LITEMAX ELECTRONICS INC., New Taipei City (TW)

(72) Inventors: CHIN-CHEN LIU, New Taipei City (TW); JUNG-CHI LO, New Taipei City (TW)

(21) Appl. No.: 17/476,495

(22) Filed: Sep. 16, 2021

(51) Int. Cl. G02F 1/133

(52) U.S. Cl. CPC G02F 1/13306

(57) ABSTRACT

A method of manufacturing liquid crystal panels with special dimensions is introduced and includes providing a standard liquid crystal panel having standard dimensions and having a plurality of pixel scan driving circuits, with the pixel scan driving circuits each including a first pixel scan driving circuit directly electrically connected to an initiating pulse circuit; and executing a laser beam mending process, such that at least one initiating pixel scan driving circuit in the pixel scan driving circuits starts later than the first pixel scan driving circuits and is bridged to the initiating pulse circuit to define a partition display area on the standard liquid crystal panel; and cutting the standard liquid crystal panel to cut the standard liquid crystal panel with standard dimensions to form a liquid crystal panel with special dimensions according to the partition display area. A liquid crystal panel with special dimensions is further introduced.

### BACKGROUND OF THE INVENTION

### 1. Field of the Invention

The present disclosure relates to technology of manufacturing liquid crystal panels with special dimensions, and in particular to a method of manufacturing liquid crystal panels with special dimensions and a liquid crystal panel with special dimensions manufactured by the method.

### 2. Description of the Related Art

Dimensions of conventional liquid crystal display products are limited by standard dimensions adopted by major panel manufacturers. To request custom-made dimensions, clients have to pay high photomask fees. The high photomask fees will not be cost-effective, if the clients place an order of just a few hundreds of liquid crystal display panels.

Prior art discloses cutting standard liquid crystal display panels to manufacture liquid crystal display panels with special dimensions. However, owing to technological advancement in liquid crystal panels, for example, advanced thin-film transistor technology, which introduces time sequence controllers provided below display screens, ultra-narrow borders, and gate arrays; as a result, routing in liquid crystal panels is increasingly complicated. Conventional post-cutting technology is no longer feasible. Crucial circuits are severed because of the cutting process, and thus the display screens fail.

### BRIEF SUMMARY OF THE INVENTION

An objective of the present disclosure is to provide a method of manufacturing liquid crystal panels with special dimensions and a liquid crystal panel with special dimensions to reduce cost and cut liquid crystal panels with standard dimensions to obtain liquid crystal panels characterized by special dimensions and capable of normal display.

To achieve at least the above objective, the first aspect of the present disclosure provides a method of manufacturing liquid crystal panels with special dimensions. The method comprising the steps of: providing a standard liquid crystal panel with standard dimensions, the standard liquid crystal panel having therein a plurality of pixel scan driving circuits, the pixel scan driving circuits each including a first pixel scan driving circuit directly electrically connected to an initiating pulse circuit; executing a laser beam mending process whereby at least one initiating pixel scan driving circuit in the pixel scan driving circuits is bridged to the initiating pulse circuit, the at least one initiating pixel scan driving circuit starting later than the first pixel scan driving circuits to define a partition display area on the standard liquid crystal panel, wherein one of the pixel scan driving circuits starts later from the at least one initiating pixel scan driving circuit and corresponds in position to the partition display area; and cutting the standard liquid crystal panel with standard dimensions according to the partition display area to obtain a liquid crystal panel with special dimension.

The second aspect of the present disclosure provides a liquid crystal panel with special dimensions, which is manufactured by the method of the first aspect.

The third aspect of the present disclosure provides a liquid crystal panel with special dimensions, comprising a transparent substrate, an initiating pulse circuit, at least one initiating pixel scan driving circuit and a bridge circuit. The initiating pulse circuit and the at least one initiating pixel scan driving circuit are disposed on the transparent substrate. The bridge circuit is disposed above the transparent substrate and below the initiating pulse circuit and the pixel scan driving circuits. The bridge circuit electrically bridges the initiating pulse circuit and the at least one initiating pixel scan driving circuit.

In an embodiment of the first aspect, the laser beam mending process is carried out to allow a plurality of initiating pixel scan driving circuits in the pixel scan driving circuits to bridge the initiating pulse circuit, and the initiating pixel scan driving circuits start late as much as the first pixel scan driving circuits do.

In an embodiment of the first aspect, during the laser beam mending process, the at least one initiating pixel scan driving circuit and the initiating pulse circuit are melted with a laser beam and thereby electrically connected to a bridge circuit. The bridge circuit passes under the at least one initiating pixel scan driving circuit and the initiating pulse circuit.

In an embodiment of the first aspect, the laser beam mending process further entails cutting off the bridge circuit from the at least one initiating pixel scan driving circuit and the initiating pulse circuit with the laser beam.

In an embodiment of the third aspect, the at least one initiating pixel scan driving circuit is in a plural number.

In an embodiment of the third aspect, a first electrically conducting channel is disposed between the bridge circuit and each said initiating pixel scan driving circuit.

In an embodiment of the third aspect, a plurality of second electrically conducting channels corresponding in number to the at least one initiating pixel scan driving circuit is disposed between the initiating pulse circuit and the bridge circuit.

In an embodiment of the third aspect, the bridge circuit has at least one breakpoint for electrically bridging the initiating pulse circuit and the at least one initiating pixel scan driving circuit.

A method of manufacturing liquid crystal panels with special dimensions and a liquid crystal panel with special dimensions, as provided by the present disclosure, dispense with any photomask with special dimensions but bridge the initiating pulse circuit to the initiating pixel scan driving circuits by laser beam mending, so as to reduce cost and cut the liquid crystal panel with standard dimensions to obtain a liquid crystal panel characterized by special dimensions and capable of normal display.

### BRIEF DESCRIPTION OF THE DRAWINGS

FIG. 1 is a schematic view of the process flow of a method of manufacturing liquid crystal panels with special dimensions according to an embodiment of the present disclosure.

FIG. 2 is a schematic view of internal circuitry of a liquid crystal panel with standard dimensions according to an embodiment of the present disclosure.

FIG. 3 is a schematic view of how to bridge an initiating pulse circuit to an initiating pixel scan driving circuit according to an embodiment of the present disclosure.

FIG. 4 is a schematic view of a liquid crystal panel with special dimensions after a partitioning process according to an embodiment of the present disclosure.

FIG. 5 is a picture of a liquid crystal panel after a laser beam mending process according to an embodiment of the present disclosure.

FIG. 6 is a partial cross-sectional view of the liquid crystal panel with special dimensions according to an embodiment of the present disclosure.

FIG. 7 is a picture of application of a display device according to an embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

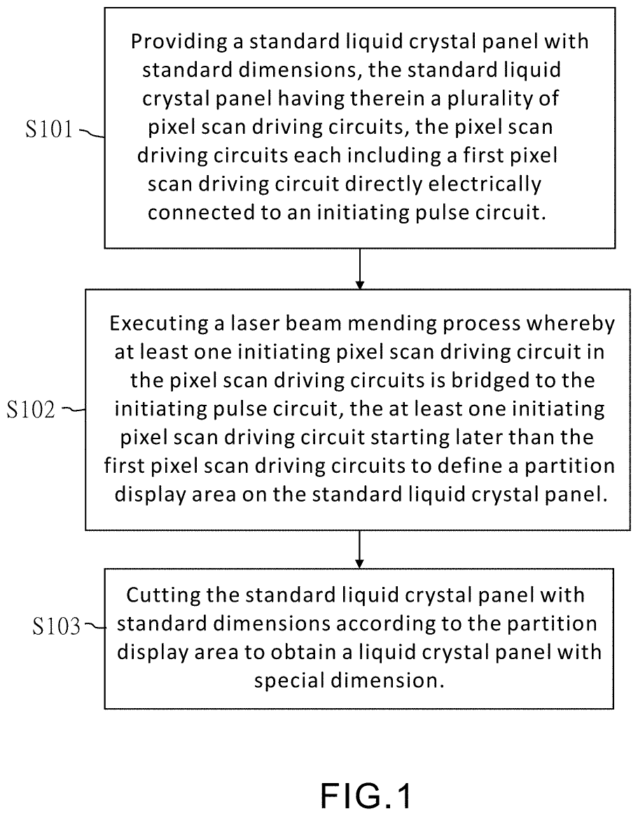

Referring to FIG. 1 through FIG. 6, the first aspect of the present disclosure provides a method of manufacturing liquid crystal panels with special dimensions. The steps of the method are described below.

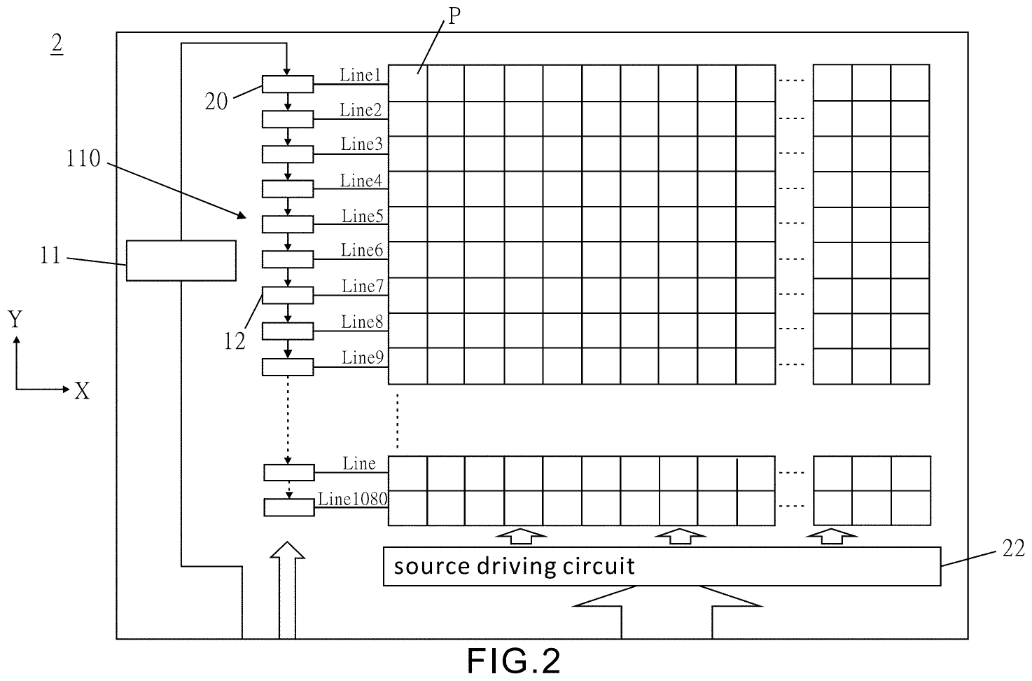

Step S101: as shown in FIG. 1 and FIG. 2, providing a standard liquid crystal panel 2 with standard dimensions, the standard liquid crystal panel 2 having therein a plurality of pixel scan driving circuits 110, the pixel scan driving circuits 110 each comprising a first pixel scan driving circuit 20 directly electrically connected to an initiating pulse circuit 11.

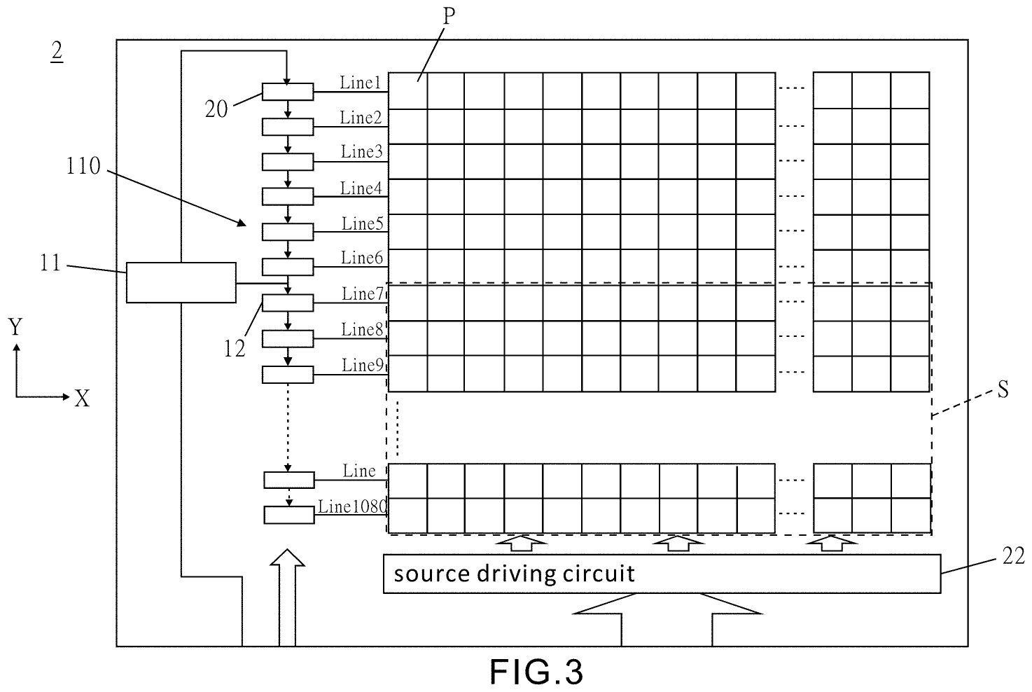

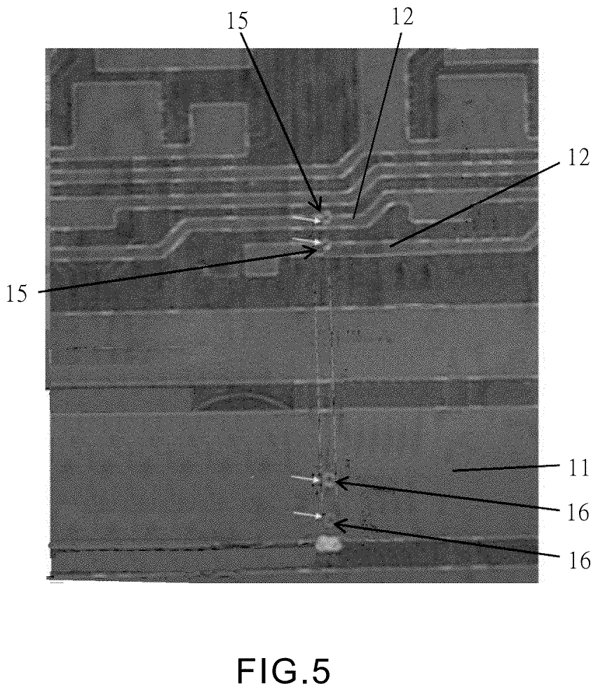

Step S102: as shown in FIG. 3 and FIG. 5, executing a laser beam mending process, such that at least one initiating pixel scan driving circuit 12 in the pixel scan driving circuits 110 is bridged to the initiating pulse circuit 11. The at least one initiating pixel scan driving circuit 12 starts later than the first pixel scan driving circuits 20, thereby defining a partition display area S on the standard liquid crystal panel 2. One of the pixel scan driving circuits 110 starts later than, and thus lags behind, the at least one initiating pixel scan driving circuit 12, and the time lag corresponds in position to the partition display area S.

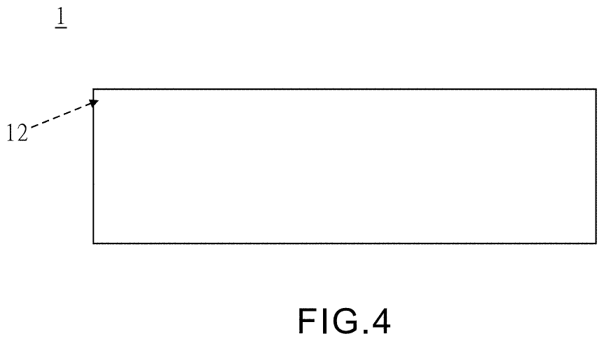

Step S103: as shown in FIG. 3 and FIG. 4, cutting the standard liquid crystal panel 2 to cut the standard liquid crystal panel with standard dimensions to form a liquid crystal panel 1 with special dimensions according to the partition display area S. The standard liquid crystal panel 2 is cut with a laser beam cutting apparatus (not shown).

Referring to FIG. 1, FIG. 4 through FIG. 6, the second aspect of the present disclosure provides a liquid crystal panel 1 with special dimensions, which is manufactured according to the first aspect of the manufacturing method.

Referring to FIG. 4 through FIG. 6, the third aspect of the present disclosure provides a liquid crystal panel 1 with special dimensions, comprising a transparent substrate 10, an initiating pulse circuit 11, at least one initiating pixel scan driving circuit 12 and a bridge circuit 13. The initiating pulse circuit 11 and the initiating pixel scan driving circuits 12 are disposed on the transparent substrate 10. The bridge circuit 13 is disposed above the transparent substrate 10 and below the initiating pulse circuit 11 and the initiating pixel scan driving circuits 12. The bridge circuit 13 electrically bridges the initiating pulse circuit 11 and the at least one initiating pixel scan driving circuit 12. The transparent substrate 10 is a glass substrate made of silicon dioxide but does not contain alkali. The liquid crystal panel 1 with special dimensions further comprises a liquid crystal thin-film, electrode, polarizer, filter and related components which are not shown.

According to the present disclosure, the method of manufacturing liquid crystal panels with special dimensions and the liquid crystal panel 1 with special dimensions dispense with a photomask with special dimensions but bridge the initiating pulse circuit 11 to the new initiating pixel scan driving circuits 12 by laser beam mending so as to reduce cost and cut the liquid crystal panel with standard dimensions to form the liquid crystal panel 1 characterized by special dimensions and capable of normal display. Slender display units each with special dimensions (for example, 16:5) can be manufactured from the formed liquid crystal panel 1 with special dimensions and applied to related fields, including process control, games, and rail-based transportation.

Refer to FIG. 2 through FIG. 4. As shown in FIG. 2, a standard liquid crystal panel 2 with standard dimensions (for example, 1920×1080) has a first pixel scan driving circuit 20. The first pixel scan driving circuit 20 is located at row Line 1 and connected to the initiating pulse circuit 11 to receive initiating pulse signals from the initiating pulse circuit 11 and transmit pulse signals downward in sequence to the pixel scan driving circuits 110 to scan sequentially along Y-axis direction the pixels P on each rows (Line 2˜Line 1080) of the standard liquid crystal panel 2. The display of the pixels P on each row is later than that on the preceding row above because of the sequence of signal transmission, but the time lag cannot be perceived by the naked eye. As shown in FIG. 3 and FIG. 4, in the embodiment of the present disclosure, the initiating pulse circuit 11 is bridged to the pixel scan driving circuits 110 which start later than the first pixel scan driving circuits 20, for example, at least one initiating pixel scan driving circuit 12 at row Line 7, such that the liquid crystal panel 1 with special dimensions resulting from cutting the standard liquid crystal panel 2 is still able to receive the initiating pulse signals, thereby allowing the display devices manufactured from the liquid crystal panel 1 with special dimensions to be able to display well.

As shown in FIG. 2 and FIG. 3, the initiating pulse signals of the initiating pulse circuit 11 originate from a plurality of gate integrated circuit components (Gate IC) (not shown), whereas the standard liquid crystal panel 2 has a source driving circuit 22 for scanning along X-axis, using high-frequency signals to arrange for data input for the sake of image display.

As shown in FIG. 3 through FIG. 6, in an embodiment, the laser beam mending process enables a plurality of initiating pixel scan driving circuits 12 in the pixel scan driving circuits 110 to be bridged to the initiating pulse circuit 11, and the initiating pixel scan driving circuits 12 start late as much as, and thus have as much time lag as, the first pixel scan driving circuits 20 do. The laser beam mending process is carried out with a laser beam mending device (not shown), but the present disclosure is not limited thereto. The laser beam mending device emits a laser beam to melt the initiating pixel scan driving circuits 12 and the initiating pulse circuit 11. The molten metal layer is electrically connected to the bridge circuit 13. The bridge circuit 13 passes under the initiating pixel scan driving circuits 12 and the initiating pulse circuit 11. A dielectric layer 14 separates the bridge circuit 13 from the initiating pixel scan driving circuits 12 and the initiating pulse circuit 11. The dielectric layer 14 is penetrated by the molten metal layer. The bridge circuit 13 is an intrinsic part of the standard liquid crystal panel 2 shown in FIG. 1, for example, and is adapted to display the pixels P. Upon completion of the laser beam mending process, the bridge circuit 13 functions as a jumper wire for connecting the initiating pixel scan driving circuits 12 to the initiating pulse circuit 11, so as to increase laser beam energy of the laser beam mending device, augment the emitted laser beam energy, and thus cut off the bridge circuit 13 from the initiating pixel scan driving circuits 12 and the initiating pulse circuit 11 and form at least one breakpoint 17, thereby preventing interference otherwise arising from reception of the initiating pulse signals from the initiating pulse circuit 11 by the initiating pixel scan driving circuits 12, albeit at the expense of the normal display of one pixel P. However, after the liquid crystal panel 1 with special dimensions has been cut out, the affected display spontaneously disappears, thereby imposing no effect on the display performance of the subsequently manufactured display devices.

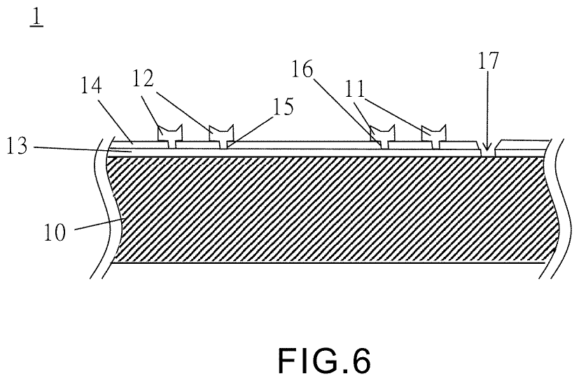

As shown in FIG. 5 and FIG. 6, in an embodiment, the at least one initiating pixel scan driving circuit 12 is in the number of two, but the present disclosure is not limited thereto. The laser beam mending process can be carried out to effect different numbers of instances of laser beam mending bridging, depending on the circuit design of the liquid crystal panel. Referring to FIG. 5, upon completion of the laser beam mending process, a first electrically conducting channel 15 is disposed between the bridge circuit 13 and each initiating pixel scan driving circuit 12, whereas a plurality of second electrically conducting channels 16 corresponding in number to the at least one initiating pixel scan driving circuit 12 are disposed between the initiating pulse circuit 11 and the bridge circuit 13.

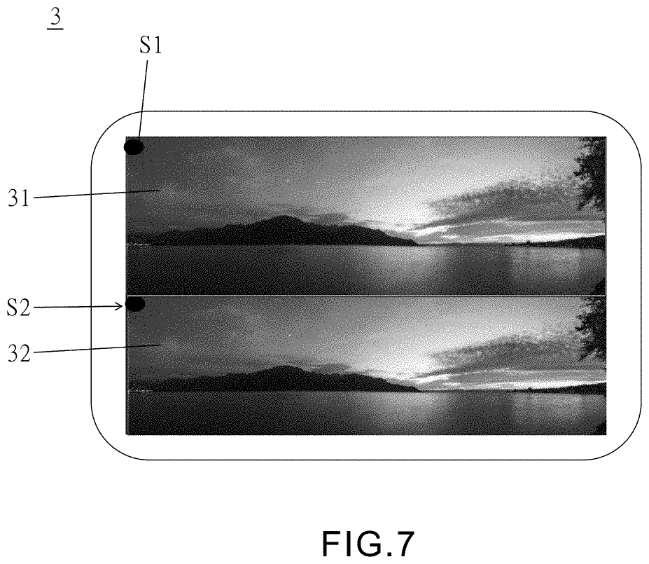

As shown in FIG. 7, when the laser beam mending process in the method of manufacturing liquid crystal panels with special dimensions according to the embodiment of the present disclosure has finished but the cutting process has not begun, a display device 3 with standard dimensions has a first area 31 and a second area 32. The first area 31 has an initiating pulse signal receiving point S1 of the liquid crystal panel with standard dimensions. The laser beam mending process enables the second area 32 to bridge the initiating pulse circuit to the pixel scan driving circuits which start late and thus have an initiating pulse signal receiving point S2. The display device 3 puts together a backlight module (not shown) and the liquid crystal panel which has not yet been cut and connects to a signal source. Meanwhile, the first area 31 and second area 32 display the same screen (at this point in time, with the cutting process having not yet begun, the source circuit can act on the first area 31 and second area, thereby allowing the first area 31 to display.) Regarding the liquid crystal panel of the display device 3, if the second area 32 is cut off from the first area 31, the second area 32 will become a liquid crystal panel with special dimensions, and thus a display device with special dimensions can be manufactured.

While the present disclosure has been described by means of specific embodiments, numerous modifications and variations could be made thereto by those skilled in the art without departing from the scope and spirit of the present disclosure set forth in the claims.

1. A method of manufacturing liquid crystal panels with special dimensions, the method comprising the steps of:
providing a standard liquid crystal panel with standard dimensions, the standard liquid crystal panel having therein a plurality of pixel scan driving circuits, the pixel scan driving circuits each including a first pixel scan driving circuit directly electrically connected to an initiating pulse circuit;
executing a laser beam mending process whereby at least one initiating pixel scan driving circuit in the pixel scan driving circuits is bridged to the initiating pulse circuit, wherein the at least one initiating pixel scan driving circuit starts later than the first pixel scan driving circuits due to signal transmission sequence, thereby defining a partition display area on the standard liquid crystal panel, wherein one of the pixel scan driving circuits starts later than, and thus lags behind, the at least one initiating pixel scan driving circuit, and the time lag corresponds in position to the partition display area; and
cutting the standard liquid crystal panel with standard dimensions according to the partition display area to obtain a liquid crystal panel with special dimension,
wherein during the laser beam mending process, the at least one initiating pixel scan driving circuit and the initiating pulse circuit are melted with a laser beam and thereby electrically connected to a bridge circuit, and the bridge circuit passes under the at least one initiating pixel scan driving circuit and the initiating pulse circuit.

2. The method of manufacturing liquid crystal panels with special dimensions according to claim 1, wherein the laser beam mending process is carried out to allow a plurality of initiating pixel scan driving circuits in the pixel scan driving circuits to bridge the initiating pulse circuit.

3. (canceled)

4. The method of manufacturing liquid crystal panels with special dimensions according to claim 1, wherein the laser beam mending process further entails cutting off the bridge circuit from the at least one initiating pixel scan driving circuit and the initiating pulse circuit with the laser beam.

5. A liquid crystal panel with special dimensions, manufactured by the method of manufacturing liquid crystal panels with special dimensions according to claim 1.

6. A liquid crystal panel with special dimensions, manufactured by the method of manufacturing liquid crystal panels with special dimensions according to claim 2.

7. A liquid crystal panel with special dimensions, manufactured by the method of manufacturing liquid crystal panels with special dimensions according to claim 3.

8. A liquid crystal panel with special dimensions, manufactured by the method of manufacturing liquid crystal panels with special dimensions according to claim 4.

9. A liquid crystal panel with special dimensions, comprising:
a transparent substrate;
an initiating pulse circuit disposed on the transparent substrate;
at least one initiating pixel scan driving circuit disposed on the transparent substrate; and
a bridge circuit disposed above the transparent substrate and below the initiating pulse circuit and the pixel scan driving circuits and electrically bridging the initiating pulse circuit and the at least one initiating pixel scan driving circuit.

10. The liquid crystal panel with special dimensions according to claim 9, wherein the at least one initiating pixel scan driving circuit is in a plural number.

11. The liquid crystal panel with special dimensions according to claim 10, wherein a first electrically conducting channel is disposed between the bridge circuit and each said initiating pixel scan driving circuit.

12. The liquid crystal panel with special dimensions according to claim 11, wherein a plurality of second electrically conducting channels corresponding in number to the at least one initiating pixel scan driving circuit is disposed between the initiating pulse circuit and the bridge circuit.

13. The liquid crystal panel with special dimensions according to claim 9, wherein the bridge circuit has at least one breakpoint for electrically bridging the initiating pulse circuit and the at least one initiating pixel scan driving circuit.
